(19) United States
(12) Patent Application Publication
(10) Pub. No.: US 2005/0081499 A1
(43) Pub. Date: Apr. 21, 2005

(54) Spindle assembly

(75) Inventor: Mark I. Serdan, West Bend, WI (US)

Correspondence Address: MICHAEL BEST & FRIEDRICH, LLP, 100 E WISCONSIN AVENUE, MILWAUKEE, WI, 53202, US

(73) Assignee: Capitol Stampings Corp., Milwaukee, WI (US)

(21) Appl. No.: 10/764,695

(22) Filed: Jan. 26, 2004

Related U.S. Application Data
(60) Provisional application No. 60/512,368, filed on Oct. 17, 2003.

(51) Int. Cl. A01D 34/03

(52) U.S. Cl. 56/295

(57) ABSTRACT

A spindle assembly for a lawnmower comprising a housing having an opening and a spindle at least partially disposed within the housing. The spindle includes a flange extending radially outwardly from the spindle within the opening and being spaced from the housing. A bearing is disposed within the housing and connects the spindle to the housing for rotational movement with respect to the housing. A seal is positioned within the housing between the flange and the bearing. The seal is a generally ring shaped member extending around the spindle and comprises a body made from a rigid material and and a lip made from a flexible material. The body is connected to the housing and is fixed with respect to the housing. The lip is connected to the body and contacts the spindle, the spindle being rotatable with respect to the seal.

### RELATED APPLICATIONS

The present application claims the benefit of prior-filed co-pending provisional patent application Ser. No. 60/512,368, filed Oct. 17, 2003.

### FIELD OF THE INVENTION

This invention relates to a spindle assembly for a lawnmower.

### BACKGROUND OF THE INVENTION

Lawnmowers generally include mower blades that are rotationally driven with respect to a frame. In some lawnmowers, the mower blades are mounted on rotary spindles supported by bearings. The bearings support the spindle relative to the frame, and also permit rotational movement of the spindle and the mower blade with respect to the frame. Lawnmowers are often used in an environment that exposes the bearings to undesirable elements, such as debris and moisture, that may lead to deterioration or failure of the bearings. Replacing deteriorated bearings is a relatively costly procedure that requires a great deal of time and effort to remove the spindle and mount new bearings on the spindle.

### SUMMARY OF THE INVENTION

The present invention provides a spindle assembly for a lawmnower having a seal to help protect the bearings from undesirable elements, such as debris and moisture. The spindle assembly includes a spindle mounted for rotation within a housing. The housing includes an opening, and the spindle extends through the opening. A gap is formed at the opening between the spindle and the housing. The spindle may include a flange to help reduce the size of the gap. The spindle assembly includes at least one bearing disposed within the housing. The bearing connects the spindle to the housing and supports the spindle for rotation relative to the housing.

The spindle assembly includes a seal disposed within the housing between the gap and the bearing. The seal contacts both the housing and the spindle and helps prevent debris and moisture from reaching the bearing. The seal includes a body and a lip. The body is a generally rigid structure to provide stability for the seal and includes an opening near the center of the seal. The lip is a relatively flexible structure and is connected to the body near the opening. The spindle extends through the opening and the lip contacts the spindle to form a seal between the lip and the spindle. The seal remains fixed relative to the housing while the spindle rotates relative to the housing and the seal.

Independent features and independent advantages of the present invention will become apparent to those skilled in the art upon review of the following detailed description, claims and drawings.

### BRIEF DESCRIPTION OF THE DRAWINGS

FIG. 1 is a cross-sectional view of a spindle assembly for a lawnmower.

FIG. 2 is an enlarged view of a portion of the spindle assembly of FIG. 1.

Before any embodiments of the invention are explained in detail, it is to be understood that the invention is not limited in its application to the details of construction and the arrangements of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting.

Although references may be made below to directions, such as left, right, up, down, top, bottom, front, rear, back, etc., in describing the drawings, these references are made relative to the drawings (as normally viewed) for convenience. These directions are not intended to be taken literally or limit the present invention in any form.

### DETAILED DESCRIPTION

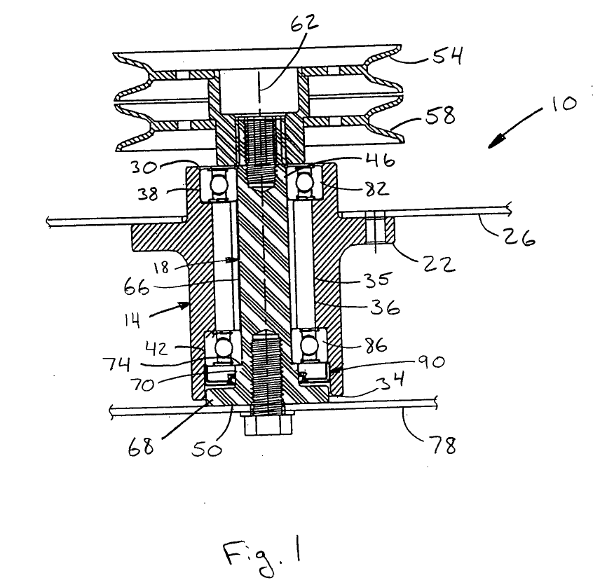

FIG. 1 illustrates a spindle assembly 10 for a lawnmower. The spindle assembly 10 includes a housing 14 and a spindle 18 mounted for rotation relative to the housing 14, and includes a mounting flange 22 extending outwardly from the housing 14. The mounting flange 22 is connected to a mower deck 26 of the lawnmower.

The housing 14 has a generally cylindrical shape and includes an upper opening 30 and a lower opening 34 at opposite ends of the housing 14. In the illustrated construction, the upper opening 30 is disposed above the mower deck 26, and the lower opening 34 is disposed below the mower deck 26. The housing 14 has an inner side wall 35 that defines a central bore 36 within the housing 14. The housing 14 also defines a first stepped portion 38 near the upper opening 30 and a second stepped portion 42 near the lower opening 34. Each stepped portion 38, 42 forms a shoulder at the end of the stepped portion 38, 42.

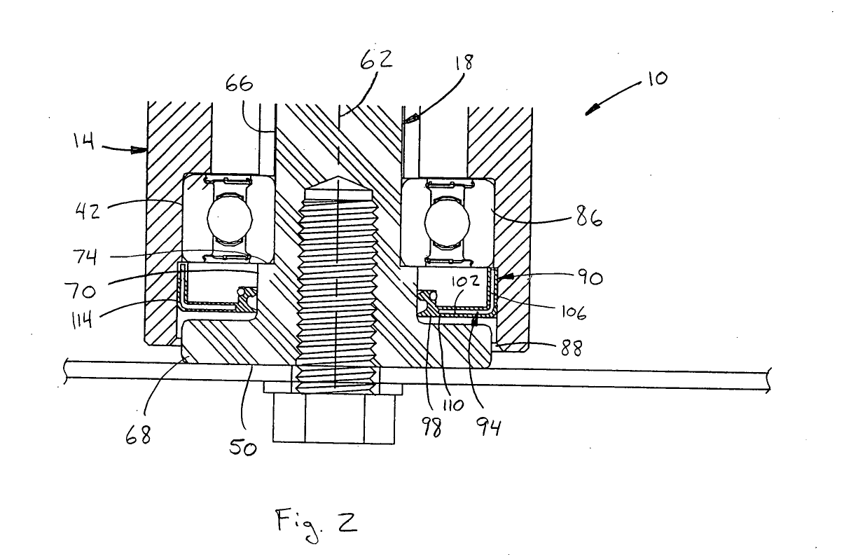

The spindle 18 extends through the housing 14 and includes a first end 46 adjacent the upper opening 30 and a second end 50 adjacent the lower opening 34. A first pulley 54 and a second pulley 58 are connected to the first end 46 of the spindle 18. A first belt (not shown) may be connected to the first pulley 54 and a rotational power source, such as an engine. The first belt transfers rotational movement from the power source to the first pulley 54, and the first pulley 54 rotates in response to rotation of the rotational power source. The spindle 18 is connected to the first pulley 54 and rotates in response to rotation of the first pulley 54. As shown in FIGS. 1-2, the spindle 18 rotates about a rotational axis 62 extending through spindle 18. A second belt may be connected to the second pulley 58 and transfers rotational power from the spindle 18 to additional spindle assembly units. In some constructions, the lawnmower may include multiple mower blades and a spindle assemblies for each mower blade. A belt-and-pulley system may be implemented to transfer rotational power to all of the spindle assemblies and mower blades.

The spindle 18 is generally an elongated shaft and includes an outer surface 66 extending along at least a portion of the length of the spindle 18. The outer surface 66 has a substantially uniform diameter and may be formed with a machining process to provide relatively tight tolerances. The spindle 18 includes a flange 68 extending radially outwardly from the spindle 18 at the second end 50. The spindle 18 also includes a ridge 70 disposed between the outer surface and the flange 68. The ridge 70 has a diameter greater than the diameter of the outer surface 66 and less than the diameter of the flange 68. The ridge 70 forms a spindle shoulder 74 between the outer surface and the ridge 70. The ridge 70 may be formed with a machining process to provide relatively tight tolerances.

A mower blade 78 is connected to the second end 50 of the spindle 18 adjacent the flange 68 and rotates along with the spindle 18. In the illustrated construction, a bolt is threaded into the second end 50 and secures the mower blade 78 to the spindle 18.

As shown in FIG. 1, the spindle assembly 10 includes an upper bearing 82 and a lower bearing 86 positioned between the spindle 18 and the housing 14. In the illustrated construction, the bearings 82, 86 are ball-bearings. Other bearings, such as roller bearings, needle bearings, or other similar suitable bearings could also be used. The bearings 82, 86 support the spindle 18 and permit the spindle 18 to rotate with respect to the housing 14. The upper bearing 82 is disposed within the first stepped portion 38 of the housing 14 and the lower bearing 86 is disposed within the second stepped portion 42 of the housing 14. Both the upper and lower bearings 82, 86 contact the outer surface 66 of the spindle 18.

As shown in FIG. 2, the flange 68 of the spindle 18 is at least partially disposed within the lower opening 34 of the housing 14. In the illustrated construction there is a slight gap 88 between the flange 68 and the housing 14, and the flange 68 generally does not contact the housing 14. In some circumstances, debris and moisture may pass through this gap 88.

A seal 90 is disposed within the housing 14 between the flange 68 and the lower bearing 86. The seal 90 provides a sealing means for resisting debris and moisture from entering the housing 14 and contacting the lower bearing 86. In the illustrated construction, the seal 90 includes a body 94 and a lip 98. The body 94 is a generally rigid structure to provide stability for the seal 90, and may be constructed of metal, hard plastic, or a similar rigid material. The body 94 provides a rigid support means for adding stability to the seal 90. The body 94 is a generally cup-shaped structure having a disc portion 102 and a ring portion 106. The disc portion 102 extends in a generally radial direction outwardly from the spindle 18 toward the housing 14. The disc portion 102 includes an opening 110 near the center of the seal 90, and the spindle 18 extends through the opening 110. The ring portion 106 is generally perpendicular with respect to the disc portion 102, and extends in a generally axial direction relative to the spindle 18 along the second stepped portion 42 of the housing 14.

The lip 98 is connected to the body 94 near the opening 110 of the disc portion 102 and contacts the spindle 18 to form a seal between the lip 98 and the spindle 18. The lip 98 provides a flexible contacting means for contacting the spindle 18 and creating a seal with the spindle 18. The lip 98 is a generally flexible structure and may be constructed of rubber, soft plastic, or some other similar flexible material. The lip 98 is generally softer than the spindle 18 to reduce wear on the spindle 18. The lip 98 is bonded to the body 94 to prevent movement of the lip 98 relative to the body 94. In the illustrated construction, the flexible rubber material of the lip 98 entirely encloses (i.e. is over-molded around) the body 94, and the lip 98 surrounds the disc portion 102 and the ring portion 106. In this construction, the body 94 is not exposed to the outside elements, such as debris and moisture. In FIG. 2, the body 94 does not directly contact the housing 14 because a portion of the lip 98 will be disposed between the body 94 and the housing 14.

In other constructions (not shown), the lip 98 may only be connected to the inner opening 110 of the disc portion 102, and parts of the body 94 may be exposed from the lip 98. In this alternate construction, the ring portion 106 may directly contact the housing 14.

As shown in FIG. 2, the lip 98 has a generally U-shaped cross-section having two ring portions that contact the spindle 18. This construction forms a double seal on the spindle 18 with the second ring forming a second seal and an additional barrier to resist debris and moisture from reaching the lower bearing 86. In other constructions (not shown), the lip 98 may only include a single ring that contacts the spindle 18 to form a single seal.

The seal 90 may be press-fit into the housing 14 to be held in place with an interference fit. The seal 90 remains fixed relative to the housing 14 while the spindle 18 rotates relative to the housing 14 and the seal 90. In the illustrated construction, the housing 14 includes a third stepped portion 114 adjacent the second stepped portion 42 and having a diameter greater than the second stepped portion 42. The seal 98 is positioned within the third stepped portion 114. In some constructions, the seal 98 may contact the lower bearing 86 to help hold the bearing 86 in position. In other constructions, the seal 98 may be spaced from the lower bearing 86 to provide free movement of the bearing 86. In the illustrated embodiment, the seal 90 is spaced apart from the flange 68, and there is a small gap between the seal 90 and the flange 68. The seal 90 does not contact the flange 68 as the spindle 18 rotates.

The foregoing detailed description describes only a few of the many forms that the present invention can take, and should therefore be taken as illustrative rather than limiting. It is only the claims, including all equivalents that are intended to define the scope of the invention.

1. A spindle assembly for a lawnmower having a deck and a blade mounted for rotation with respect to the deck, the spindle assembly comprising:
a housing defining an opening and being connectable to the deck;
a spindle at least partially disposed within the housing and having an end extending through the opening and beyond the housing, and being mounted for rotation with respect to the housing about a rotational axis;
at least one bearing disposed within the housing and connecting the spindle to the housing for rotational movement; and
a seal disposed within the housing between the opening and the at least one bearing to resist materials from passing from the opening to the at least one bearing.

2. The spindle assembly of claim 1, wherein the spindle includes a flange extending radially outwardly from the end of the spindle within the opening and being spaced from the housing, the blade being connectable to the flange.

3. The spindle assembly of claim 2, wherein the seal is disposed between the flange and the at least one bearing

4. The spindle assembly of claim 1, wherein the seal is fixed with respect to the housing and the spindle is rotatable with respect to the seal.

5. The spindle assembly of claim 4, wherein the seal is connected to the housing with an interference fit.

6. The spindle assembly of claim 1, wherein the seal is a generally ring shaped member extending around the spindle and comprises a body having an outer ring portion contacting the housing and an inner ring portion and a lip connected to the inner ring portion and contacting the spindle.

7. The spindle assembly of claim 6, wherein the body is made from a rigid material and the lip is made from a flexible material.

8. The spindle assembly of claim 7, wherein the body is entirely surrounded by a flexible rubber material.

9. The spindle assembly of claim 6, wherein the lip is bonded to the body.

10. The spindle assembly of claim 6, wherein the lip includes two ring shaped portions spaced apart from one another and contacting the spindle.

11. A spindle assembly for a lawnmower having a deck and a blade mounted for rotation with respect to the deck, the spindle assembly comprising:
a housing defining an opening and being connectable to the deck;
a spindle at least partially disposed within the housing and being mounted for rotation with respect to the housing about a rotational axis, and having a flange extending radially outwardly from the spindle within the opening and being spaced from the housing, the blade being connectable to the flange;
at least one bearing disposed within the housing and connecting the spindle to the housing for rotational movement; and
a seal disposed within the housing between the flange and the at least one bearing to resist materials from passing from the opening to the at least one bearing, the seal being a generally ring shaped member extending around the spindle comprising a body made from a rigid material and having an outer ring portion connected to the housing and an inner ring portion and a lip made from a flexible material and connected to the inner ring portion and contacting the spindle, the seal being fixed with respect to the housing and the spindle being rotatable with respect to the seal.

12. The spindle assembly of claim 11, wherein the seal is connected to the housing with an interference fit.

13. The spindle assembly of claim 11, wherein the body is entirely surrounded by a flexible rubber material.

14. The spindle assembly of claim 11, wherein the lip is bonded to the body.

15. The spindle assembly of claim 11, wherein the lip includes two ring shaped portions spaced apart from one another and contacting the spindle.

16. A spindle assembly for a lawnmower having a deck and a blade mounted for rotation with respect to the deck, the spindle assembly comprising:
a housing defining an opening and being connectable to the deck;
a spindle at least partially disposed within the housing and having an end extending through the opening and beyond the housing, and being mounted for rotation with respect to the housing about a rotational axis;
at least one bearing disposed within the housing and connecting the spindle to the housing for rotational movement; and
a sealing means disposed between the opening and the at least one bearing for resisting materials from passing from the opening to the at least one bearing.

17. The spindle assembly of claim 16, wherein the sealing means includes a rigid support means connected to the housing and a flexible contacting means contacting the spindle.

18. The spindle assembly of claim 17, wherein the rigid support portion is fixed with respect to the housing and the spindle is rotatable with respect to the flexible contacting means.

19. The spindle assembly of claim 17, wherein the flexible contacting means includes two ring shaped portions spaced apart from one another and contacting the spindle.

20. The spindle assembly of claim 17, wherein the rigid support means is connected to the housing with an interference fit.
